(19) United States
(12) Patent Application Publication
(10) Pub. No.: US 2013/0117036 A1
(43) Pub. Date: May 9, 2013

(54) METHODS AND SYSTEMS FOR INTELLIGENT ROUTING OF HEALTH INFORMATION

(71) Applicant: Cognosante Holdings, LLC, McLean, VA (US)

(72) Inventors: Robert M. COTHREN, Walnut Creek, CA (US); Dale WILL, Arlington, TX (US)

(73) Assignee: COGNOSANTE HOLDINGS, LLC, McLean, VA (US)

(21) Appl. No.: 13/631,409

(22) Filed: Sep. 28, 2012

Related U.S. Application Data
(60) Provisional application No. 61/540,811, filed on Sep. 29, 2011.
(60) Provisional application No. 61/601,479, filed on Feb. 21, 2012.

(51) Int. Cl. G06F 19/00

(52) U.S. Cl. CPC G06F 19/30
USPC 705/2

(57) ABSTRACT

An intelligent router for performing functions such as data aggregation from multiple sources, data mining, business intelligence analysis, exploratory data analysis, confirmatory data analysis, predictive data analysis, text analytics, and routing of the results to the appropriate recipient(s) at the appropriate time. The router may comprise an authorization/access manager, a business rules management system, routing engine, data aggregator, community data analytics engine.

### DESCRIPTION OF RELATED APPLICATIONS

This application claims priority to U.S. Provisional Patent Application No. 61/540,811, filed on Sep. 29, 2011. This application also claims priority to U.S. Provisional Patent Application No. 61/601,479, filed on Feb. 21, 2012. The contents of these provisional applications are incorporated herein by reference in their entirety.

### BACKGROUND OF THE INVENTION

The Office of the National Coordinator for Health Information Technology (ONC) defines health information exchange (HIE) as the process of reliable and interoperable electronic health-related information sharing conducted in a manner that protects the confidentiality, privacy, and security of the information while employing nationally recognized standards. HIE often refers to the act of sharing data, while health information organizations (HIOs) are one of the primary organizations that implement and operate the technologies that share the information.

The recent emphasis on the adoption of electronic health records (EHRs) and the so-called “meaningful use” of EHR technology as called for in the American Recovery and Reinvestment Act of 2009 (ARRA) goes far to make electronic health information available for sharing. At the same time, HIE is rapidly maturing into a more common method for securely sharing health information for the purposes of enabling better-informed and higher quality care delivery. The hope and expectation is that EHRs and HIE will become a common and important tool in the care delivery protocols for every provider.

The Medicare Payment Advisory Commission defines an accountable care organization (ACO) as a set of physicians and/or hospitals that accept joint responsibility for the quality of care and the cost of care received by their panel of patients. The goal is to create an incentive for providers in the ACO to constrain volume growth while improving the quality of care.

Section 3022 of the Patient Protection and Affordable Care Act (ACA) creates the Medicare Shared Savings program, allowing ACOs to contract with Medicare and share in the savings realized by the ACO. The ACO is one example of an organized system of care (OSC) that utilizes a specific care delivery and business model to manage quality of care and healthcare costs. Other OSCs, which are similar to ACOs, are being formed at the state and local levels such as health access networks (HANs) and coordinated care organizations (CCOs). The interdependency of HIE and OSC is that the OSC is the care delivery business model that requires data mobility, and HIE is the effective means of providing that mobility.

American Academy of Family Physicians, American Academy of Pediatrics, American College of Physicians, and American Osteopathic Association jointly defined the patient-centered medical home (PCMH) as an approach to providing comprehensive primary care that facilitates partnerships between individual patients and their personal providers, and, when appropriate, the patient's family. The interdependency of HIE and PCMH is that the PCMH is an approach to organizing care delivery that requires data mobility, and HIE is an effective means of providing that mobility. However, data mobility alone is insufficient to effectively enable a successful OSC or PCMH.

The process of HIE is driven by specific actions of the health care providers—usually requesting information on a patient that is presenting for care, either emergently or as part of a scheduled visit. This presents the provider with two problems:
a. The provider or other authorized individual must usually take an active role in requesting health information. As a result, he/she may not learn of important health events that do not result in the patient presenting in the provider's office, or important changes in the care of a patient that he/she did not take an active role in making. For example, the provider would not be made aware of a patient presenting to the emergency department or of changes in daily medication that might result from that emergency health event.
b. When such a request is made, the provider is presented with a large volume of information, much of which may be of no utility to the provider for the current health event. As more and more health information is made available electronically, this will soon result in “information overload,” in which the provider is so overwhelmed by health information that important pieces of relevant information are missed. The potential for information overload results in concerns that HIE will actually decrease the quality of care or increase provider liability in the event that health information was available, but the provider failed to identify it and properly act upon it.

Some prior art systems have attempted to collect and process HIE and EHR. However, these prior art systems generally require a particular healthcare IT vendor's software product. The present application is directed to a method and system for intelligent routing of health information which is not constrained to a particular clinical data repository for its data sources as are some of the prior art systems. Additionally, unlike some prior art systems, the system and method for intelligent routing of health information described herein does not require any one particular healthcare IT vendor's software product stack as a prerequisite for its functional capabilities. The architecture of the invention is universal in its form and functionality and can, through its flexible business rules and fact extractors, adapt to any standardized data set and structure. The invention can work with any healthcare IT vendor's software product stack including, but not limited to, HIEs, EHRs, hospital information systems, lab information systems, radiology information systems, and pharmacy information systems. The invention is not limited to commercial off-the-shelf products but rather can easily adapt to custom developed healthcare IT software applications and legacy systems.

### SUMMARY OF THE INVENTION

In general, the present application is directed to systems and methods for providing an intelligent router that enables HIOs, OSCs, and other healthcare organizations to use flexible, easily changed business rules to enable the secure and timely delivery of health information.

In providing a solution to this problem, a method and system for intelligent routing of health information (intelligent router) is described. Such an intelligent router may contain software and circuitry for transferring and processing health information. The intelligent router may include a software program stored on a computer readable medium and executed by a processor or microprocessor within a computer or central server. The computer or central server may also be part of the intelligent router, wherein the intelligent router includes a computer or a server as well as the program instructions stored on a computer readable medium and executed by the computer or server. It may be used by any authorized recipient of health information such as a healthcare professional, public health official, or family member responsible for providing care. While not intended to be a replacement for EHRs or HIE, the intelligent router is designed to make use of electronic health information provided by EHRs and other systems, while the electronic infrastructure of the HIE may provide the backbone to move the health information. The intelligent router can direct the movement of health information based on a set of business rules that direct the actions of the router and events that initiate exchange of information.

The intelligent router may be designed to provide timely delivery of important health information to those that need certain information at the time they need it. In contrast to prior systems that require an authorized individual or organization to request information, an authorized individual using the intelligent router can automatically receive alerts of the existence of relevant information, or receive the information itself, based on important health events and a set of actions to take. Both the types of events that initiate actions and the actions to take are defined by adjustable business rules.

The business rules, which may be logical rules stored within memory of the intelligent router computer system, can be used by a microprocessor of the intelligent router to select information that is most relevant or most important to receive. While an authorized individual can request additional information through normal HIE mechanisms, with adjustable business rules, the processor of the intelligent router can identify and select specific information that the individual has identified as relevant or of greater importance.

Standard health delivery practices manage health care events. EHRs and HIE hold the promise of better informing the provider in managing those events. By providing important and relevant health information outside of the context of the patient presenting to the provider's office, the intelligent router enables the management of disease and of patient health.

In some embodiments the intelligent router can contain:
a. An Authorization/Access Manager
b. A Business Rules Management System (BRMS)
c. A Routing Engine
d. A Data Aggregator; and
e. A Community Analytics Engine.

According to some embodiments, the intelligent router may enhance the security of data via definitive, organization specific business rules executed by a real time business rules management engine. The router may also enable cost saving analytics for OSCs and other organizations. The intelligent router works in conjunction with existing data exchanges to apply rules to data flowing through the exchange. For OSCs, this can mean monitoring and alerting appropriate personnel when OSC members present for services in non-OSC locations, or when the care of OSC members is altered by other providers. The intelligent router may also bring demonstrable value to an HIE by enabling HIEs to identify potential issues arising with their constituents. Additionally, in some embodiments the router may scan, in real time, data flowing across an exchange to enable information to be directed to appropriate members of a patient's PCMH, to public health professionals for surveillance purposes, to researchers investigating best practices, or to OSC physicians to help manage chronic conditions.

The intelligent router may, by way of example, assist OSCs in the areas of disease management by sending:
a. timely reminders to patients and their physicians;
b. coordination of care alerts when a patient visits a healthcare provider outside of the patient's medical home;
c. administrative alerts when a patient needs to renew their enrollment pending expiring coverage;
d. fraud, waste and abuse alerts when a member is filling multiple prescriptions for narcotics; and
e. wellness alerts to remind patients to receive scheduled immunizations, or preventative services that they are scheduled to receive.

### BRIEF DESCRIPTION OF THE FIGURES

FIG. 1 illustrates a schematic view of the intelligent router.

FIG. 2 illustrates a schematic view of the authorization/access manager.

FIG. 3 illustrates a schematic view of the data aggregator.

FIG. 4 illustrates a schematic view of the routing engine.

FIG. 5 illustrates a schematic view of business rules management system.

FIG. 6 illustrates a schematic flow diagram of information related between a requester, HIE partners, other data sources, and the intelligent router according to an embodiment of the invention.

FIG. 7 illustrates an example of the flow of data through the intelligent router.

### DETAILED DESCRIPTION OF THE FIGURES

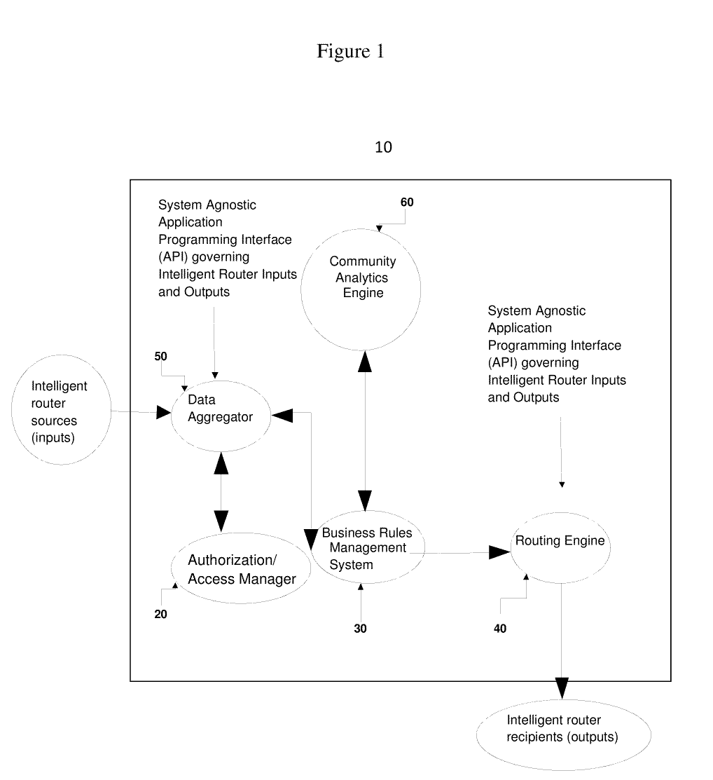

As shown in FIG. 1, an intelligent router 10 can contain an authorization/access manager 20, a business rules management system 30, a routing engine 40, a data aggregator 50, and a community data analytics engine 60. The intelligent router 10 may be placed into existing electronic data streams, and may collect information from multiple sources. These sources may include hospitals, physician's offices, clinics, pharmacies, out-patient centers, and the like. The collected data may be a combination of demographics data, clinical data, patient-specific data, administrative data, insurance claims data, and scheduling data.

The intelligent router 10 may aggregate the data collected from the multiple sources. In addition, the intelligent router may conduct data mining, a data analysis technique that focuses on modeling and knowledge discovery for predictive rather than purely descriptive purposes. In conducting data mining, the intelligent router 10 can search the collected data for specific types of information, and the intelligent router 10 may be configured to automatically perform data mining or may perform data mining in response to search requests input from a user. The intelligent router 10 also performs business intelligence analysis on the aggregated data. In some embodiments, the business intelligence analysis may focus on business information, such as healthcare claims data and healthcare provider practice pattern analytics.

The intelligent router 10 may also perform exploratory data analysis in order to discover new features in the aggregated data, or to group together relevant, related information in the aggregated data. The intelligent router 10 may also perform confirmatory data analysis to confirm or refute an existing hypothesis such as measuring the efficacy of a particular treatment pattern for a given diagnosis, predictive data analysis (focuses on the application of statistical or structural models for predictive forecasting), and text analytics applying statistical, linguistic, and structural techniques to extract and classify information from textual sources containing unstructured data. After collecting and aggregating the data from various sources and performing data analysis, the intelligent router 10 may then route the results to the appropriate recipient(s) at the appropriate time.

As noted above, the intelligent router 10 can aggregate data from many sources when interacting with a HIE engine. The breadth and depth of the information available to the members/constituents of the HIE for analysis vastly exceeds the information usually available to a single organization, thus allowing the intelligent router to determine more statistically and clinically relevant results.

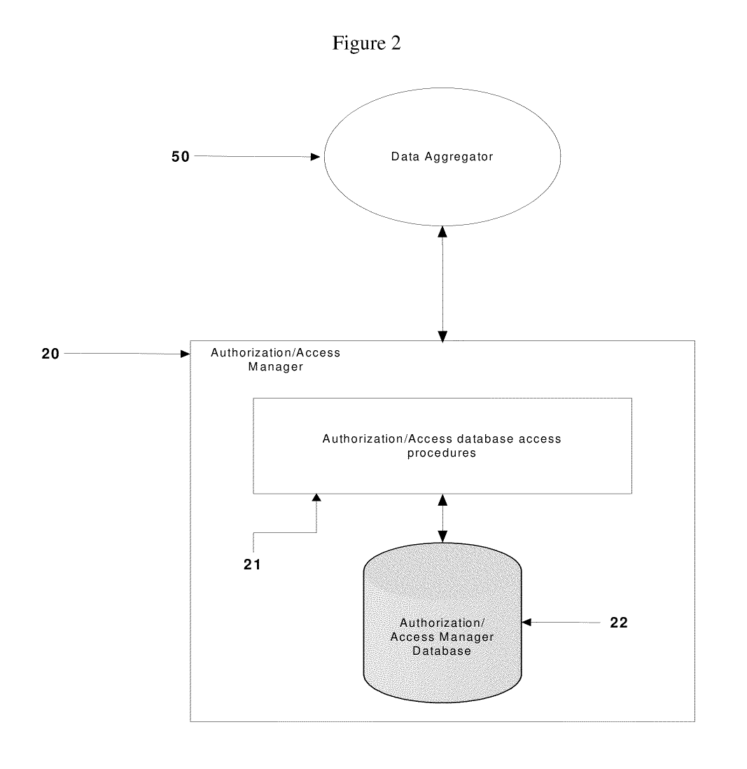

As shown in FIG. 2, the authorization/access manager 20 can act as a gatekeeper for access to the other components of the intelligent router. When called for, the authorization/access manager 20 checks to ensure the requester, typically a healthcare provider or other authorized users utilizing an HIE or an EHR system, has the appropriate authorization to access the components of the intelligent router. The authorization/access manager 20 may contain an authorization/access manager database 21 and an authorization/access database access procedures module 22. The authorization/access manager database 21 contains a database of information indicating access rights to information in the intelligent router. The authorization/access database access procedures module 22 contains access codes for information contained in the authorization/access manager database 21.

When a requester seeks access to the intelligent router, the authorization/procedures module 22 queries the requester to input an access code. If the authorization/procedures module 22 confirms that the access code input by a user matches an existing code stored in the module 22, the module 22 provides the user with access to information in the authorization/access manager database 21 for that particular code. Different access codes may be stored for different information within the database. For example, one access code may provide a requester with access to a patient's upcoming scheduled appointments, while a different access code may provide a user with access to the patient's entire EHR. Alternatively, one access code may provide the user with access to all information within the database, or all information within the database for a particular patient, organization, disease, treatment program, or other area of health information. The authorization/access manager 20 is also in communication with the data aggregator 50. As the data aggregator 50 attempts to receive information from certain sources, the source may first require the data aggregator 50 to input access credentials. The data aggregator 50 communicates with the authorization/access manager 20, which provides the proper access information for the particular source. The data aggregator 50 then relays this access information to the information source and, after access is granted, begins collecting data from the source. The authorization/access manager 20, and data aggregator 50, may be implemented within a computer or server. In some embodiments, the authorization/access manager 20 and data aggregator 50 include databases stored on a computer memory. The processing and analysis performed by the authorization/access manager 20 and data aggregator 50 may be accomplished by executing software program instructions stored on a computer readable medium using a processor.

The community analytics engine 60 supports the analytics that are needed by the organization utilizing the router. These analytic needs span a broad spectrum including evaluation of the efficacy of new protocols, evaluation of guidelines and care plans, monitoring of the costs associated with care delivery, monitoring of care delivery locations, and highlighting the impacts of the local care decisions. The community analytics engine 60 can provide this analytic processing intelligence for both patient centric analysis and population analysis.

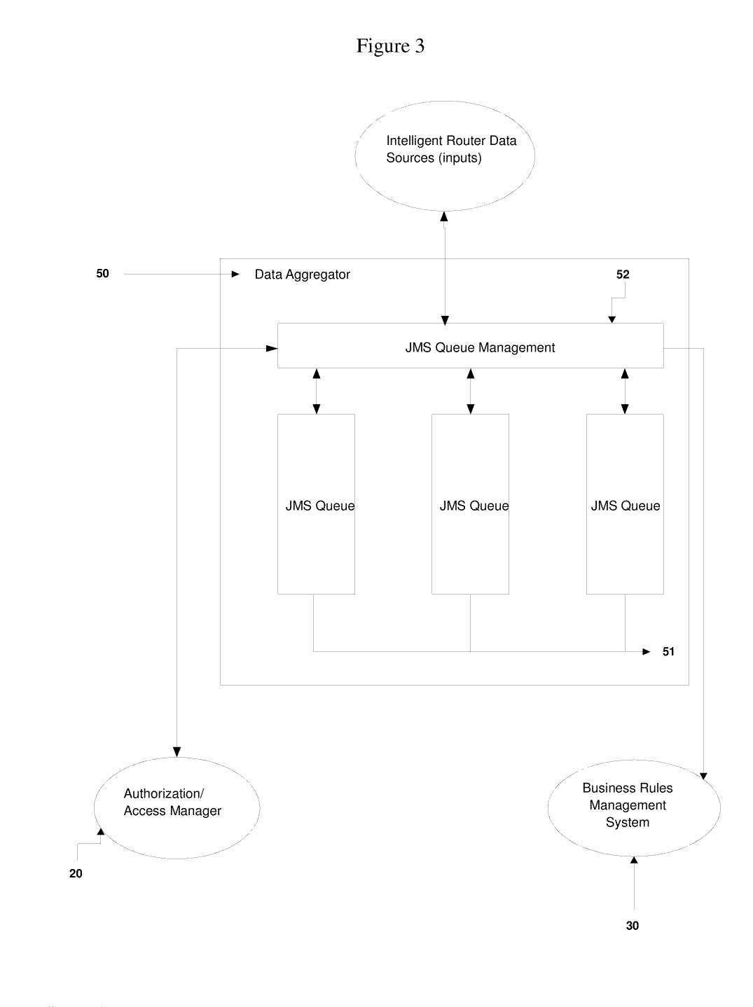

As shown in FIG. 3, the data aggregator 50 receives data from external sources. Data can be collected through any number of methods including a direct interface through a network connection or an enterprise service bus. The data aggregator 50 may perform an aggregation of the data into a patient-centric view, and may also create aggregated population based data. The data aggregator 50 can be built using message service queues 51 such as Java Message Service (JMS). Using JMS queue management within the data aggregator 50, inbound data may be collected and queued until all data is received from the intelligent router data sources. The message service queue management 52 enables the management of the data from the intelligent router data sources that is stored in each queue. Although FIG. 3 denotes three queues, more or less queues can be used as needed. The number of active queues is fluid, and may depend on the number of data requests that occur in parallel. This approach enables the intelligent router to gather and store data, in parallel, that will be needed for business rules management system 30.

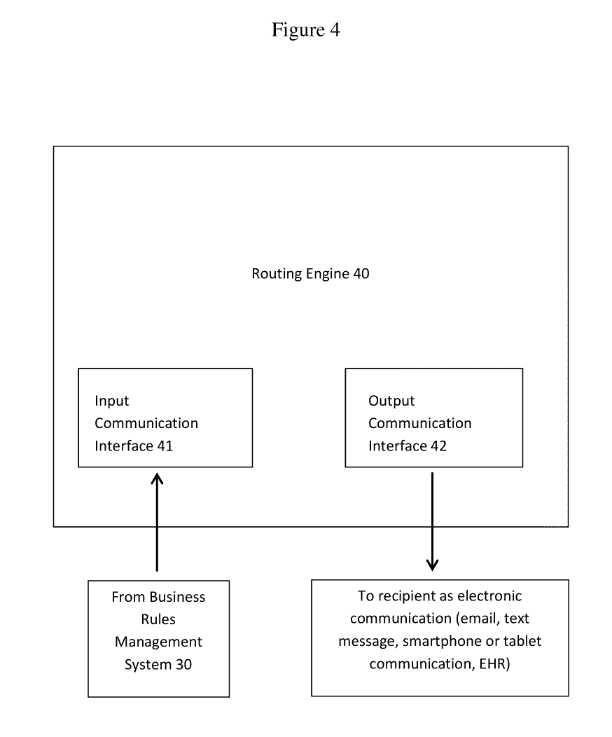

FIG. 4 is an illustration of the routing engine 40 of the intelligent router system. The routing engine 40 is the business rule driven component that ensures the right data gets to the right recipient at the right time. In other words, the routing engine 40 receives instructions from the business rules management system 30 that describe when and where the information must be distributed. The routing engine 40 contains an input communication interface 41, which is in communication with the business rules management system 30 accepting input from the business rules management system 30 in the form of an alert, a notification, or any type of digital payload. The routing engine 40 further includes an output communication interface 42, which allows the routing engine 40 to transmit actionable alerts or other messages to an end user. The output communication interface 42 may include a modem or other connection to the internet or other network communication medium. The output communication interface 42 may allow the transmission of EHRs, secure email, text messages, updates within a mobile application running on a smartphone or tablet, updates to a web page, or other electronic communication. The business rules management system 30 may communicate with the input communication interface 41 on the routing engine 40, and the routing engine 40 may receive instructions from the business rules management system 30. In some embodiments, after the business rules management system 30 determines a message or alert that should be sent to an end user, it provides instructions to the routing engine 40 to transmit the message or alert at a certain time. The routing engine 40 receives these instructions, and ensures that a proper message or alert is sent to the end user at the proper time using the output communication interface 42.

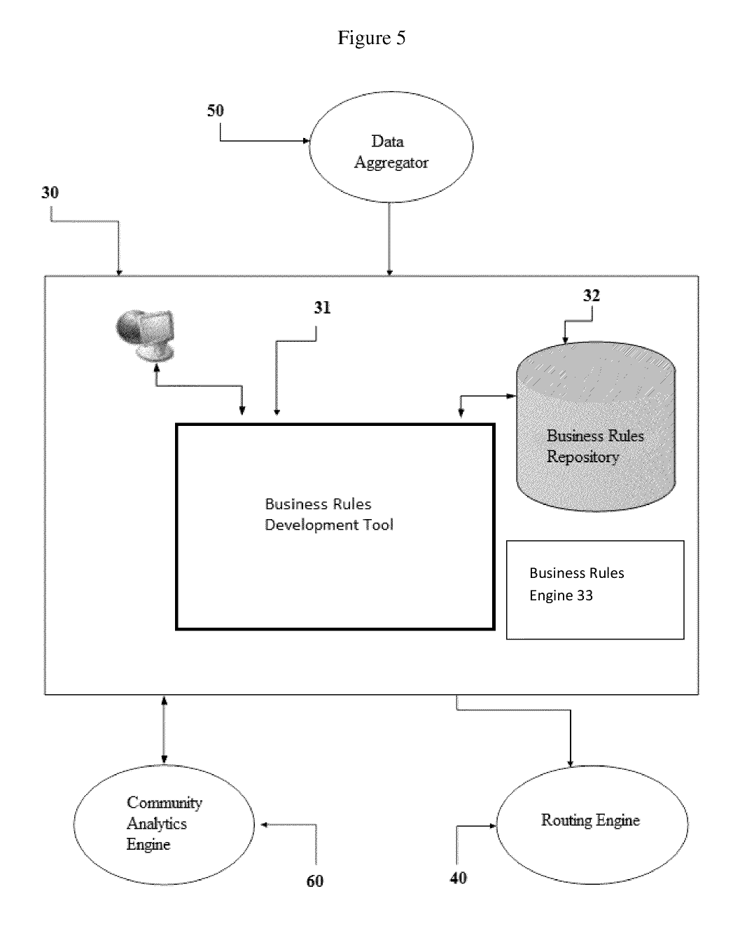

FIG. 5 illustrates the business rules management system 30. As shown in FIG. 5, the business rules management system 30 may be in communication with the data aggregator 50, community analytics engine 60 and routing engine 40. The business rules management system 30 utilizes business rules—statements that define or constrain the actions of the router—in order to instruct the type of information to be included in an alert or message, the recipients of the alerts or message, and the time or time period when the message or alert should be distributed. The business rules may be created within a business rules development tool 31, which allows a user to create customizable business rules tailored to organization or user preferences. These business rules may model the business processes of an organization by describing the operations, definitions and constraints that apply to an organization's access and distribution of health information. The business rules management system 30 provided in the intelligent router is the storage location for the business rules and the means for a user to manage—create, alter, or delete—specific business rules. An exemplary, business rules management system includes:
a. A business rules repository 32, that enables the storage and distribution of those rules. In commercial deployment, a rule starter pack may be included to provide users with templates and examples of how rules may be deployed and programmed.
b. A rules development tool 31, for both technical developer and business experts, necessary to construct the business rules. The rules development tool 31 may be implemented as a web-based graphical user interface tool that enables the technical developer(s) and business expert(s), collectively referred to as development tool users, to access the business rules repository. Once the business rules repository 32 is accessed the development tool user may have the ability to create, read, update or delete business rules.
c. A rules engine 33, that executes one or more business rules from the business rules repository in a runtime production environment. Since business rules change more frequently than application code, the rules engine 33 represents the component that executes business rules in an environment separate from application code.
d. A runtime environment containing a combination of software, e.g., runtime engines, and hardware. The software may provide common routines and functions that the applications require, and may convert the program from a written language, such as Java, into executable machine language. The hardware may include a CPU that enables the business rules management system to operate by executing the software programs.

Referring back to FIG. 1, and as mentioned above, the intelligent router 10 may contain several components such as an authorization/access manager 20, a business rules management system 30, a routing engine 40, a data aggregator 50, and a community analytics engine 60. One or more of these five components described above may be implemented as software modules within a common host computer or server. Alternatively, one or more of the five components may be a self-contained computer system which interacts with and exchanges data with the other components through communication interfaces. The initial interaction with the intelligent router 10, by external systems may be through the data aggregator 50. The data aggregator 50 receives, at its input, data/information from external sources such as HIEs, EHRs, lab information systems, public health systems, and the like. Once data is received, the data aggregator 50 has two paths: one for receiving access from the authorization/access manager 20 (access is granted before the data aggregator may begin collecting data in some configurations) and another for outputting the data to the business rules management system 30. More particularly:
a. Interaction with the authorization/access manager 20 in order to ensure access is granted. The interface between the data aggregator 50 and the authorization/access manager 20 is bi-directional, and data flows in two directions from the data aggregator 50 to the authorization/access manager 20 and vice versa. Once the authorization/access manager 20 confirms access via its internal authorization table, which defines what users may or may not have access to in the data aggregator 50, the output of the authorization/access manager 20 is a message either allowing or disallowing access to other components of the intelligent router.
b. Once the authorization/access manager 20 grants access to the data aggregator 50, the data aggregator 50 passes data that was accumulated using messaging services, such as industry standard JMS queues, to the business rules management system 30.
c. The input to the business rules management system 30 is the data accumulated by the data aggregator 50. This data is transmitted electronically to the business rules management system 30. The business rules management system 30 uses this data to select the appropriate business rules and executes those business rules using a computing device with a memory and processor, such as a general purpose computer.

Based upon the data input from the data aggregator 50, the business rules engine 33 will choose and execute the appropriate rules. These rules are stored in the business rules management system business rules repository 32.

The results of the executed business rules drive the business rules management system 30. The execution of the selected rules may result in the business rules management system 30 providing a complete result set. An example of this is a rule stating that when the input from the data aggregator 50 indicates a patient is receiving care outside of ACO, the ACO's care management team and the patient's primary care physician will be notified. The result of this rule requires no further processing except for passing the appropriate information to the routing engine 40. Alternatively, the execution of the selected rules may result in the business rules management system 30 requesting additional processing by the community data analytics engine 60 to form a result set. An example of this is a rule that requires the calculation of the number of re-admits with congestive heart failure. In this case, the community data analytics engine 60 would receive the request for this analysis. Upon completion of the analysis, the community data analytics engine 60 would return information to the business rules management system 30. The business rules management system 30 would pass the appropriate information to the routing engine 40. The community data analytics engine 60 can execute several types of analytic routines on the results supplied by the business rules management system 30. Once the routines are completed, the community data analytics engine 60 will output the analytic results to business rules management system 30.

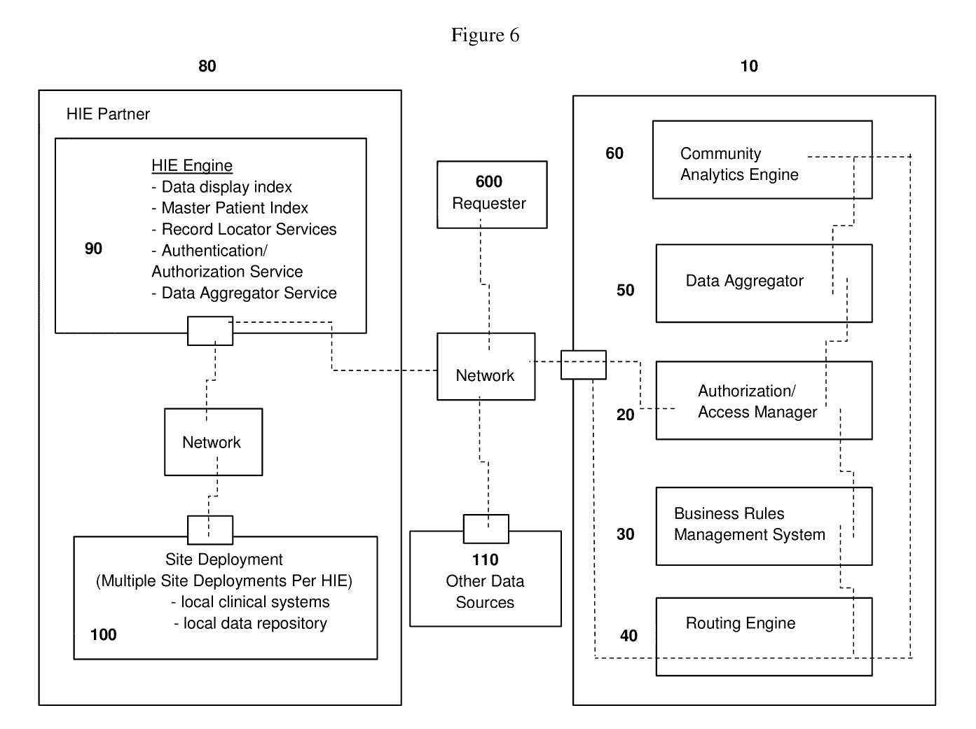

FIG. 6 presents a visual representation of a process flow of information from HIE data sources 80 and other data sources 110, through the intelligent router 10, and to the information requester 600.

Once the information has been processed by the intelligent router 10, the router 10 sends the information to the initial requester 600. The router 10 passes the information through an optional firewall and, as shown, the router 10 sends the information back to the originating requester 600 and the HIE engine 90. Upon delivery to the HIE engine 90, the HIE engine 90 will perform additional processing of the received information to generate certain results depending on the payload generated.

As seen in FIG. 6, a request or data input from an originating requester 600 is transmitted through a network communication system to the intelligent router 10. The intelligent router 10 receives the request or data input, and transmits it to the request to the authorization/access manager 20. The authorization/access manager 20 ensures that the requester 600 has the proper credentials to access the information requested. If the authorization/access manager 20 determines that the requester 600 is allowed access to the information requested, the authorization/access manager 20 transmits the request to the data aggregator 50 and business rules management system 30. The business rules management system 30 receives the information request or data input, and ensures that the applicable business rules relating to the type of information, patient, requesting entity, and other factors are applied to the request.

The authorization/access manager 20 and business rules management system 30 communicate with the data aggregator 50, and inform the data aggregator 50 of the sources of information that will have to be accessed as well as the type of information that will need to be acquired or monitored. The data aggregator 50 interfaces with HIE partners 80 as well as other data sources 110 to retrieve the necessary data. The HIE partner 80 may include an HIE engine 90 that includes a data display index that routes data and that may include a display for the data in a website portal or internal network portal. The HIE engine 90 may further include a patient index, record locator service, authorization service and data aggregation service. The HIE partner may also include site deployment 100, with multiple site deployments 100 per HIE. The site deployment 100 may include local clinical systems, and local data repositories. The other data sources 110 may include state registries, public health departments, school health databases, and the like.

The data aggregator 50 communicates with the HIE partner 80 and other data sources 110 to retrieve the necessary data and data messages. This data is then transmitted from the data aggregator to the community analytics engine 60, if additional processing is necessary, which analyzes the data. The community analytics engine 60 sends the analyzed data to the router engine 40. The analyzed data may be in the form of a final report, or may be a collection of analyzed data. The router engine 40 forwards the analyzed data to the business rules management system 30. The business rules management system 30 applies the stored business rules to the data, and informs the router engine 40 when and to whom the data should be distributed. The business rules management system 30 may format the data into a final message form for distribution before sending to the router. Alternatively, the routing engine 40 may perform this message formatting before sending the data to the initial requester 600 and any other receiving parties. The router engine 40 transmits the formatted message over the network communication connection to the initial requester 600, as well as the HIE partner 80 and any other parties that may require the information to keep the EHRs relating to an individual, community, geographic area, disease, treatment, or other type of medical information complete.

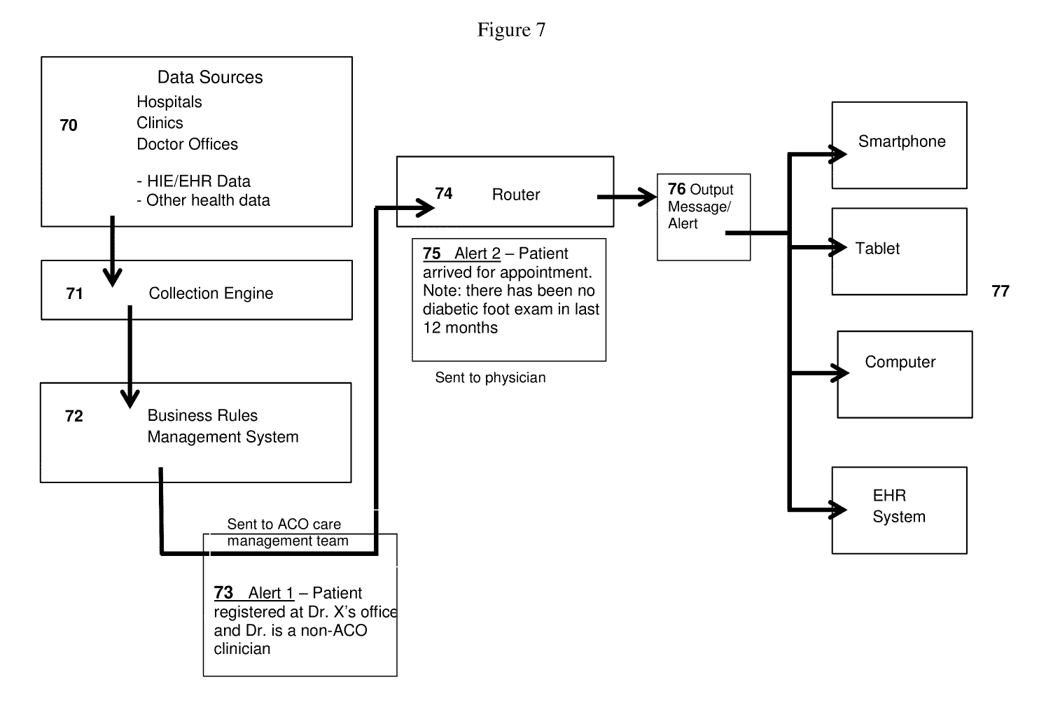

FIG. 7 illustrates an example of the conversion of information retrieved from a plurality of data sources into a specific alert sent to selected users using an embodiment of the intelligent routing system. As shown in FIG. 7, a plurality of data sources 70 are accessed by a collection engine 71. The collection engine may be located within the data aggregator 50. The plurality of data sources 70 may include hospitals, clinics, physician's offices, laboratories, pharmacies, health insurance companies, and the like. The intelligent routing system may be placed into communication with the plurality of sources over a network connection using network communication interfaces. Alternatively, the intelligent routing system may be placed into the internal information system of the data sources, and may communicate information from the internal information system of the data source to the data aggregator and collection engine of the intelligent router system.

The data from the plurality of sources may be provided in a message format, such as the message formatting used by JMS, which is captured by the collection engine 71. The captured data may conform to the Health Level 7 framework and related standards for the exchange, integration, sharing, and retrieval of electronic health information. The captured data may also be in the form of Continuity of Care Documents, or any other file layout containing health information. The collection engine 71 processes the captured data to break the message or document down into its relevant elements or facts. Based upon the message type and originating source or location, the collection engine may reach out to EHRs, HIEs, or other data sources to gather needed data such as previous diagnoses, lab results or tests performed, patient background information, or other types of historical data. The collection engine 71 processes the collected information to match collected data with users, link required business processes to collected data, and link people, such as doctors, pharmacists, and patients, to information necessary for the continued treatment of an individual. The collection engine 71 then transmits the collected and processed data to a business rules management system 72.

The business rules management system 72 applies specific rules to the collected data to determine pertinent health information, such as preventative information, diagnostic information, or treatment information. The business rules management system 72 enables customizable, site-specific, easily constructed, standards based business rules to be constructed. The standard used may be Business Process Module and Notation, Version 2. The business rules operate on the data provided from the collection engine 71, and prepare results for transmission through the intelligent router. The business rules management system 72 provides the user with a customizable, flexible system to adjust the rules for collecting, analyzing, and routing information to best the user's business needs. The business rules management system 72 provides context and meaning to the collected data, and provides the ability to enhance the exchange of health related information through intelligent extraction and timely communication of data. As shown in FIG. 7, after processing of the collected data according to the stored business rules, the business rules management system 72 may output an alert message 73 including relevant data. For example, the message may be about a specific patient's most recent activity.

The output message 73 may be transmitted from the business rules management system to a router 74, which may be part of the routing engine 40 as shown in FIG. 1. The router 74 takes the relevant alert 73, or other information, and converts it into a format for receipt by an end user. The alerts and messages received from the business rules management system 72 may be converted by the router into router output messages 75, 76. These output messages 75, 76 may be in a variety of formats including EHRs, secure email messages, data or text messages, or other electronic communications. For example, the business rules management system 72 may receive an alert that a patient has registered for an appointment. The business rules management system 72 may apply its internal business rules to this information, and provide notations for the system to provide an appointment reminder to the patient, provide a scheduling reminder to the physician, and access the patient's history to search for any information relevant to the upcoming appointment. The business rules management system 72 may additionally create an alert within the system to send a message when the patient arrives and checks-in for the scheduled appointment, along with any relevant patient history that the physician may need for the appointment, as shown at 75. As shown at 76, these messages and alerts generated by the business rules management system 72 are communicated to the router 74, which converts them into the proper form and distributes them to the proper receiving party at the appropriate time. For example, message 76 regarding a patient's arrival for a scheduled appointment may be transmitted as a text or data message to a smart phone or tablet. Alternatively, the message may be transmitted as an email, received at a computer or other device with email access capability. The message may also be sent as part of an EHR for storage in a patient's EHRs, or may be provided as an update to a website or network record system.

As an example, usage of the intelligent routing system may pertain to OSCs such as an ACO, CCO, HAN, or a care management team within a state Medicaid organization. In this scenario, an OSC has a designated group of patients whose care they are responsible for managing. When the OSCs are ACOs, CCOs, or HANs, these types of OSC are also at risk for managing the cost of care, and it is of particular importance to know when one of the patients is about to seek care in an emergency room that might otherwise be handled in a normal office visit. In the case of a care management team within a state Medicaid organization, it is of particular clinical importance to be aware of acute medical events for the high risk patient population these care management teams typically manage for early and frequent intervention. In these scenarios, the intelligent router may function as follows. The collection engine may have, as some of its data sources, a list of patients to monitor activity within the OSC, their medical home healthcare providers or care managers, and the healthcare providers preferred method of notification. Additionally, the collection engine simultaneously receives real-time notifications from a data feed supplied by an ANSI 270 healthcare eligibility electronic data interchange transaction processing system from within a healthcare insurance carrier (Medicaid, Medicare, or Private Insurance). The collection engine extracts the relevant facts about the transaction, including the location from which the eligibility transaction is emanating.

The business rules engine then determines if the transaction is emanating from an emergency room department, and if so, checks to see if the patient involved is one of the patients to monitor on behalf of the OSC. If a match is made, additional facts are extracted from the patient's record, including the identity of their medical home healthcare provider. Once the provider is identified, additional facts are extracted to determine the destination and the preferred method of notification of the event. The business rules management system then produces a pre-determined output message based on the event type that will notify the healthcare provider that one of their patients is about to be seen at an emergency room. This message and the destination and preferred method of transmission are passed to the routing engine, where the message may undergo additional processing. The message is then sent by the routing engine via the preferred method identified for each provider (secure e-mail, or SMS txt, for example). Once the notification is sent, a transmission log is written to a log file, and the event is complete.

The intelligent router can be constructed through the use of commercial, off the shelf components in combination with customized middleware as described above. Open source products may also be used. In an exemplary embodiment, the data aggregator, authorization/access manager, business rules management system, and routing engine may be developed using customized open source software components or commercial off-the-shelf (COTS) products. The community analytics engines may be developed using a COTS product. When COTS products are used, a system, comprising middleware, implementing, connecting, and programming the COTS would be configured as described herein. The middleware may be implemented based on a model-view-controller framework such as Struts or Spring. Model-View Controller (MVC) is a software architecture, currently considered an architectural pattern used in software engineering. The pattern isolates “domain logic,” i.e., the application logic for the user from the user interface (input and presentation), permitting independent development, testing and maintenance of each. Struts is an example of a MVC based framework. Struts is an open source framework which make building of the web applications easier based on the Java Servlet and Java Server pages technologies. Spring is an MVC Framework that is architected and designed in such a way that every piece of logic and functionality is highly configurable thus allowing easy integration with other popular frameworks like Struts.

Java or a similar programming language may be used to code the middleware and its routines. An integrated development environment may also be used in the development of the intelligent router. In some embodiments, the intelligent router may be deployed in a Microsoft Windows server environment or Unix/Linux, or other environment. In some embodiments, the intelligent router may be deployed as a server running software running stored on computer readable media. The software may be stored and run from a cloud computing service, or the software may be stored in a network attached storage device. The intelligent router's web deployment may be managed using a web server and an application server. An application server may be a software system/package that provides an environment in which applications, such as the intelligent router, can run. Web servers may be computers that deliver or serve up Web pages.

It is hereby claimed:

1. An intelligent router system for routing of health information, comprising:
a. an authorization/access manager;
b. a data aggregator configured to collect information from a plurality of data sources;
c. a business rules management system, wherein the business rules management system includes a business rules development tool and a business rules data repository; and
d. a routing engine configured to transmit messages and alerts relating to health information based on the business rules.

2. The intelligent router system of claim 1, further comprising a community analytics engine.

3. The intelligent router system of claim 1, wherein the intelligent router system is configured to utilize existing data streams.

4. The intelligent router system of claim 1, wherein the authorization/access manager comprises an access database of information indicating access rights to information within the intelligent router system, and a processing module containing access codes for the access database.

5. The intelligent router system of claim 1, wherein the data aggregator includes a communication interface for accessing information from external sources.

6. The intelligent router system of claim 1, wherein the data aggregator includes message service queues.

7. The intelligent router system of claim 1, wherein the routing engine comprises an output communication interface configured to transmit alerts or messages to information requesters.

8. The intelligent router system of claim 1, wherein the routing engine transmits a message or alert, the contents of which are determined according to the business rules management system, to the requester at an appropriate time as determined by the business rules management system.

9. The intelligent router system of claim 1, wherein the business rules development tool is configured to allow a user to create flexible rules to adapt to any standardized data set or data structure.

10. A method of intelligent routing of health information, comprising:
a. receiving a request for health information through a network communication system, wherein the request is received at an intelligent router system;
b. transmitting the request to an authorization manager within the intelligent routing system;
c. forwarding the request from the authorization manager to a data aggregator and a business rules management system within the intelligent router system;
d. collecting information from internal and external sources with the data aggregator, and aggregating and analyzing the collected information;
e. applying business rules to the aggregated and analyzed data with the business rules management system; and
f. outputting a message or alert to the requester from a routing engine.

11. The method of claim 10, wherein the data aggregator includes a collection engine which breaks messages received from information sources into relevant pieces and which adds historical information.

12. The method of claim 10, wherein the business rules management system generates an alert or message based on the input data in a first format.

13. The method of claim 12, further comprising transmitting the alert or message in the first format to the routing engine, and transmitting the alert or message from the routing engine to a requester in a second format.

14. The method of claim 10, further comprising transmitting data from the business rules management system or data aggregator to a community analytics engine.

15. The method of claim 14, wherein the community analytics engine performs patient-centric and population-based analysis.

16. The method of claim 10, wherein the output message or alert is packaged to be transmitted in the form of an email, text message, electronic health record, or mobile application message.

17. The method of claim 10, wherein the authorization manager determines whether a requester is allowed access to the information requested.

18. The method of claim 10, wherein the routing engine transmits the output message or alert, the contents of which are determined according to the business rules management system, to the requester at an appropriate time as determined by the business rules management system.
